(19) United States
(12) Patent Application Publication
(10) Pub. No.: US 2002/0068597 A1
(43) Pub. Date: Jun. 6, 2002

(54) APPARATUS FOR AND METHOD OF AUTOMATICALLY ANSWERING AN INCOMING TELEPHONE CALL AND PROVIDING A STATUS MESSAGE TO CALLER

(76) Inventor: RICHARD K. SCHEEL, PLEASANTON, CA (US)

Correspondence Address: HAVERSTOCK & OWENS LLP, 162 NORTH WOLFE ROAD, SUNNYVALE, CA, 94086, US

(21) Appl. No.: 09/128,163

(22) Filed: Aug. 3, 1998

(51) Int. Cl. H04M 11/10; H04M 1/00; H04B 1/38

(52) U.S. Cl. 455/550

(57) ABSTRACT

An automated answering message system includes an automatic answer mode switch which enables a user to switch between automatic and manual answering modes. When the manual answering mode is selected, the telephone will function in its normal manner, ringing until answered. In the manual answering mode the user must answer an incoming call manually by pressing an answer button. When the automatic answering mode is selected, the telephone is allowed to ring once when an incoming call is detected, thereby notifying the user of the call. After this first ring, the automated answering message system then automatically answers the call. A message answer mode switch is also included enabling a user to switch between message and non-message modes. When the non-message mode is selected and an incoming call is answered, no message is played while the caller waits for the user to take the call. When the message mode is selected and an incoming call is answered, a recorded message notifies the caller that the user is currently in an inappropriate setting in which to answer the call but will be on the line momentarily. In an alternate embodiment, the telephone is equipped with a light which will flash after a call has been automatically answered until the user joins the call. In a further alternate embodiment, the telephone will not ring at all before an incoming call is automatically answered and the flashing light or vibration of the telephone will notify the user that there is an incoming call being held.

### FIELD OF THE INVENTION

The present invention relates to the field of telephones and telephone answering systems. More particularly, the present invention relates to the field of automatically answering an incoming call and providing a message to a caller.

### BACKGROUND OF THE INVENTION

Cellular telephones provide convenience and safety to users by giving the users the ability to make and receive calls from any location where cellular service is available. The ability to receive calls on a cellular telephone is limited to the times when the telephone is turned on. When the telephone is turned off, a caller will normally receive a message provided by the cellular service provider that the user is currently unavailable or is not within a service area. With some systems, a caller calling when a user's telephone is turned off will be able to leave a voice message for the user with the service provider. The user can then retrieve such a message by calling into the service provider.

While it is important for a user of a cellular telephone to be reachable for important calls, there are times and locations where answering such an incoming call is disruptive and inappropriate. One example of such a location is a meeting being attended by the user. While it may be necessary for the user to have their telephone turned on during attendance of a meeting, having the telephone ring in the middle of the meeting can be very disruptive to the other participants. Typically, when receiving such a call during a meeting the user will either answer the call in the room, thereby disrupting the meeting with their talking, or will let the telephone ring until the user gets outside of the room and answers the call, which is also very disruptive to the meeting.

With conventional telephone sets in homes and offices there are also times when the user may want to accept incoming calls, but letting the telephone ring until answered is disruptive. One such time is at home when a child or other person is sleeping. Letting the telephone ring until it is answered by the user can have the potential of awakening the person who is sleeping.

What is needed is a method of automatically answering an incoming telephone call and notifying the caller that the user will take their call momentarily, thus allowing the user to leave the room without disrupting the meeting with the incoming call. What is further needed is a method of notifying the user in the least disruptive manner when such an incoming call is automatically answered.

### SUMMARY OF THE INVENTION

An automated answering message system automatically answers an incoming call. The automated answering message system includes an automatic answer mode switch which enables a user to switch between an automatic answering mode and a manual answering mode. When the manual answering mode is selected, the telephone will function in its normal manner, ringing until answered. In the manual answering mode the user must answer an incoming call manually by pressing an answer button. When the automatic answering mode is selected, the telephone is allowed to ring once when an incoming call is detected, thereby notifying the user of the call. After this first ring, the automated answering message system then automatically answers the call. A message answer mode switch is also included enabling a user to switch between a message mode and a non-message mode. When the non-message mode is selected and an incoming call is answered, no message is played while the caller waits for the user to take the call. When the message mode is selected and an incoming call is answered, a recorded message notifies the caller that the user is currently in an inappropriate setting in which to answer the call but will be on the line momentarily. The user then joins the call as soon as it is a convenient time and place. In an alternate embodiment, the telephone is equipped with a light which will flash after a call has been automatically answered until the user joins the call. In a further alternate embodiment, the telephone will not ring at all before an incoming call is automatically answered and a flashing light or vibration of the telephone will notify the user that there is an incoming call being held.

### BRIEF DESCRIPTION OF THE DRAWINGS

FIG. 1 illustrates a block diagram schematic of the components within a telephone of the preferred embodiment of the present invention.

FIG. 2 illustrates a block diagram schematic of the components within an alternate embodiment of the telephone of the present invention.

FIG. 3 illustrates a flow diagram of the steps involved in automatically answering an incoming call according to the preferred embodiment of the present invention.

### DETAILED DESCRIPTION OF THE PREFERRED EMBODIMENT

An apparatus for automatically answering an incoming telephone call and providing a status message to the caller allows a user to answer an incoming call automatically with a recorded message, thereby putting the caller on hold until the user is able to pickup the call. The recorded message notifies the caller that the user is currently in an inappropriate setting in which to answer the call but will be on the line momentarily. The automated answering and message system of the preferred embodiment of the present invention includes an automatic answer mode switch and a message answer mode switch which are both activated and deactivated by external switches on the telephone. Alternatively, the automatic answer mode switch and the message answer mode switch are internal and can be activated and deactivated using the telephone's keypad.

The automatic answer mode switch enables a user to switch between an automatic answering mode and a manual answering mode. When the manual answering mode is selected, the telephone will function in its normal manner, ringing until answered. When the telephone is in the manual answering mode, the user must answer an incoming call manually by pressing an answer button. Alternatively, the user can manually answer the telephone in any other appropriate and available manner. When the automatic answering mode is selected, the automated answering and message system preferably allows the telephone to ring once for an incoming call, thereby notifying the user of the call. In an alternative embodiment of the present invention, the telephone includes the capability to notify the user of the incoming call through a ring or if the ringing function is turned off, through a flashing light, vibrating of the telephone or any other appropriate notifying means. When the automatic answering mode is selected, after the telephone rings once and the user is notified of the incoming call, the automated answering and message system of the present invention automatically answers the call.

The message answer mode switch enables a user to switch between a message mode and a non-message mode. When the non-message mode is selected and an incoming call is answered, no message is played while the caller waits for the user to take the call. When the message mode is selected and an incoming call is answered, the automated answering and messaging system plays a recorded message for the caller, notifying the caller that the user is currently in an inappropriate setting in which to answer the call but will be on the line momentarily. The user can then join the call as soon as it is convenient to do so.

When the automatic answer mode switch is in the manual answering mode and the message answer mode switch is in the non-message mode, the telephone will function in its normal manner, ringing until answered. The preferred embodiment of the automated answering message system is implemented within a cellular telephone. However, as should be apparent to those skilled in the art, alternatively the automated answering message system of the present invention can be implemented on any telephone. In an alternate embodiment, the telephone is equipped with a light which flashes after a call has been automatically answered and until the user joins the call. This flashing light is activated to remind the user that there is a caller waiting on the line. If the call is disconnected before the user joins the call, the flashing light is deactivated. In still a further alternate embodiment, the telephone will not ring at all before an incoming call is automatically answered. In this embodiment, a flashing light will notify the user that there is an incoming call being held. In still a further embodiment, a telephone will vibrate to notify the user that there is an incoming call.

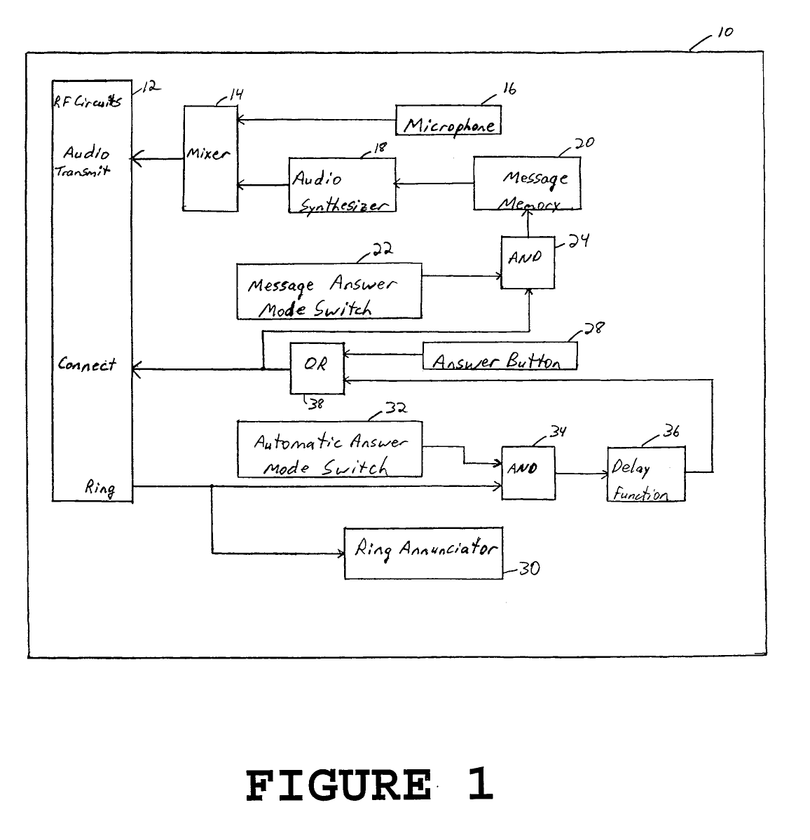

A block diagram schematic of the components within a telephone of the preferred embodiment of the present invention is illustrated in FIG. 1. Within the telephone 10, the radio frequency circuits 12 control the telephony functions of detecting a call, initiating a ring sequence, connecting to the call when answered and transmitting and receiving audio information. The ring signal is generated by the radio frequency circuits 12 and is coupled to the ring annunciator 30 which generates an audible ring from the telephone 10. This ring signal is also coupled as an input to a logical AND gate 34. An output from an automatic answer mode switch 32 is also coupled as an input to the logical AND gate 34. The output of the automatic answer mode switch 32 is preferably at a logical high voltage level when the system is in the automatic answering mode. Otherwise, if the system is in the manual answering mode, the output of the automatic answering mode switch 32 is at a logical low voltage level. Preferably, the automatic answering mode switch 32 is an external switch on the telephone. Alternatively, the automatic answering mode switch 32 is an internal switch which is controlled by the user through the telephone's keypad.

An output of the logical AND gate 34 is coupled as an input to a delay function circuit 36. An output of the delay function circuit 36 is coupled as an input to the logical OR gate 38. When its input is activated the delay function circuit 36 starts a timer to wait for a delay period. After the delay period, the delay function circuit 36 then activates its output. The delay period is preferably set to allow the telephone to audibly ring once. When the output of the logical AND gate 34 rises to a logical high voltage level, signalling that the automatic answer mode switch 32 is in the automatic answer mode and the ring signal has been activated for an incoming call, the delay function circuit 36 will start the timer and wait for the delay period allowing the telephone to audibly ring once before the output of the delay function circuit 36 is activated and raised to a logical high voltage level.

An output from an answer button 28 is also coupled as an input to the logical OR gate 38. The output from the answer button 28 is raised to a logical high voltage level when the answer button 28 is activated. When either the answer button 28 is activated or the output of the delay function circuit 36 is raised to a logical high voltage level, the output of the logical OR gate 38 is raised to a logical high voltage level. The output of the logical OR gate 38 is coupled to the radio frequency circuits 12 and as an input to a logical AND gate 24. When the output of the logical OR gate 38 is raised to a logical high voltage level, the incoming call is answered by the radio frequency circuits 12 and a connection with the incoming call is established.

An output from a message answer mode switch 22 is coupled as an input to the logical AND gate 24. The output from the message answer mode switch 22 is maintained at a logical high voltage level if the message mode is selected. If the non-message mode is selected, then the output from the message answer mode switch 22 is maintained at a logical low voltage level. Preferably, the message answer mode switch 22 is an external switch on the telephone. Alternatively, the message answer mode switch 22 is an internal switch which is controlled by the user through the telephone's keypad.

An output of the logical AND gate 24 is coupled to a message memory 20 in order to activate playback of a recorded message stored in the memory 20 if the incoming call has been answered and the message answer mode switch 22 is in the message mode. The message memory 20 is preferably a non-volatile memory which stores the message for playback in a digital form. An output of the message memory 20 is coupled to an audio synthesizer 18 for synthesizing the message output from the message memory 20 thereby forming an audio signal which is output by the audio synthesizer 18. An output of the audio synthesizer 18 is coupled to an input of a mixer circuit 14. An output of the mixer circuit 14 is coupled to an audio transmit circuit within the radio frequency circuits 12. A microphone 16 is also coupled as an input to the mixer circuit 14 to allow the user to communicate through the telephone with the caller.

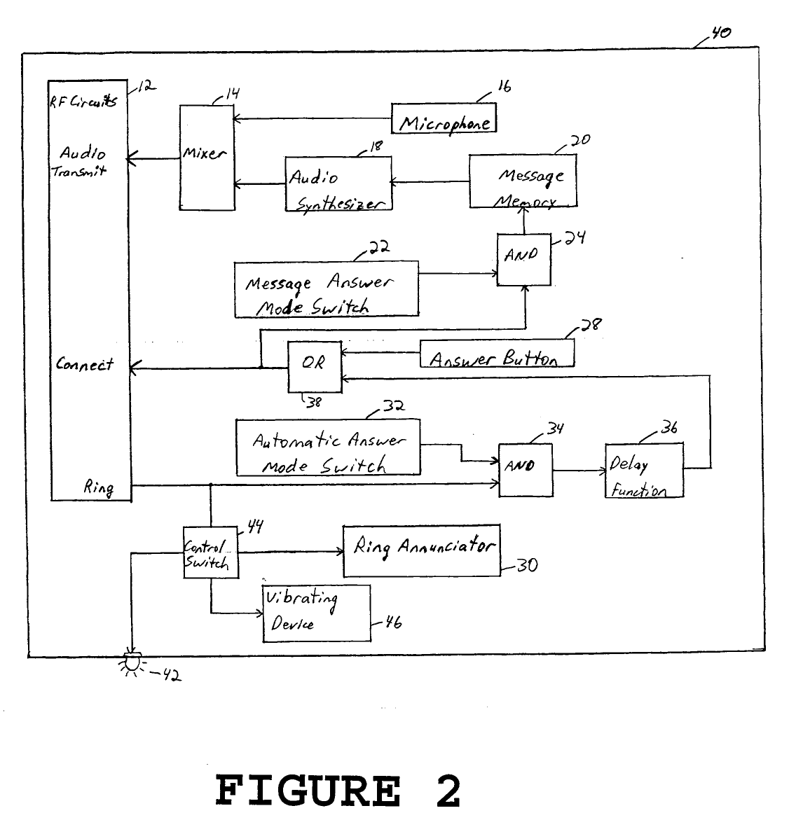

A block diagram schematic of an alternate embodiment of the telephone of the present invention is illustrated in FIG. 2. This embodiment of the telephone 40 includes all of the components of the telephone 10 illustrated in FIG. 1, with the addition of the control switch 44, the vibrating device 46 and the light 42. The control switch 44 is coupled to receive the ring signal from the radio frequency circuits 12. The control switch 44 enables the user to choose how they wish to be notified of an incoming call. Preferably, the control switch 44 is an external switch on the telephone. Alternatively, the control switch 44 is an internal switch which is controlled by the user through the telephone's keypad. Through the control switch 44, the user can select to receive notification through any one or a combination of the ring annunciator 30, the vibrating device 46 and the light 42. When the ring signal is activated, signalling that a call is incoming, the control switch 44 will activate the output or outputs corresponding to the selected one or ones of the ring annunciator 30, the vibrating device 46 and the light 42. When activated by the control switch 44, the ring annunciator 30 will generate an audible ringing noise. When activated by the control switch 44, the vibrating device 46 will cause the telephone to vibrate. When activated by the control switch 44, the light 42 will flash. In an alternate embodiment, the vibrating device 46 and/or the light 42 can be activated after an incoming call is automatically answered, until the user joins the call, thereby serving as a reminder to the user that there is a call waiting which has been answered.

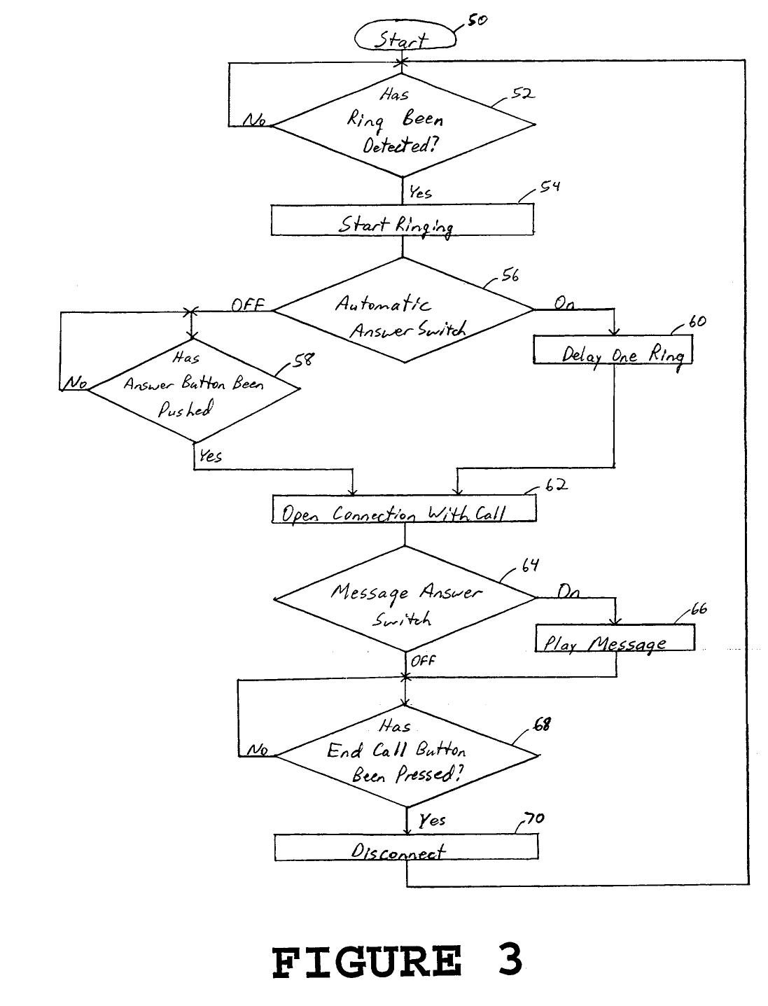

A flow diagram of the steps involved in automatically answering an incoming call and providing a message to the caller according to the present invention, is illustrated in FIG. 3. The flow chart is entered at the step 50, when the telephone is turned on. The telephone then waits at the step 52 until a ring from an incoming call is detected. Once a ring from an incoming call is detected, the ringing procedure is initiated which activates the ring signal from the radio frequency circuits 12. The telephone then determines at the step 56, if the automatic answer mode switch 32 is in the automatic answering mode or the manual answering mode. If the telephone is not in the automatic answering mode, the incoming call is not automatically answered and the telephone will wait at the step 58 until the incoming call is manually answered by the user. Otherwise, if the telephone is in the automatic answering mode, the telephone will delay for the delay period. The delay period preferably is a time period long enough to allow the ring annunciator 30 to produce one audible ring, at the step 60. After the delay period of step 60, if the telephone is in the automatic mode, or if the incoming call is manually answered at the step 58, a connection is opened with the incoming call at the step 62.

At the step 64 it is then determined if the message answer mode switch 22 is in the message mode or the non-message mode. If the message answer mode switch 22 is in the message mode, then the message recorded in the message memory 20 is played for the caller at the step 66. After the message has been played at the step 66, the telephone waits at the step 68 and keeps the connection with the incoming call open until the end call button is pressed, signalling that the user is terminating the call. If the message answer mode switch 22 is in the non-message mode, then the telephone waits at the step 68 and keeps the connection with the incoming call open until the end call button is pressed. Once the end call button is pressed signalling that the user is terminating the call, the call is disconnected at the step 70 and the telephone returns to the step 52 until a new incoming call is detected.

In the preferred embodiment of the present invention, the message memory 20 is a non-volatile memory in which the user can record a message to be played for callers when a call is answered and the message answer mode switch 22 is in the message mode. Alternatively, the message memory 20 is a fixed read-only memory (ROM) in which a general message is recorded. In this embodiment the user cannot record their own message.

When the automatic answer mode switch 32 is in the automatic answering mode, a ring signal activated for an incoming call will raise the output of the logical AND gate 34 to a logical high voltage level, causing the delay function circuit 36 to initiate a timer for the delay period, allowing the telephone to ring once. Once the delay period is over, the output of the delay function circuit 36 is raised to a logical high voltage level, causing the output of the logical OR gate 38 to be raised to a logical high voltage level. Otherwise, if the automatic answer mode switch 32 is in the manual answer mode, then the output of the logical OR gate 38 is raised when the answer button 28 is pressed by the user. When the output of the logical OR gate 38 is raised to a logical high voltage level, the incoming call is answered and a connection with the incoming call is opened.

When the output of the logical OR gate 38 is at a logical high voltage level and the message answer mode switch 22 is in the message mode, the output from the logical AND gate 24 is raised to a logical high voltage level. When the output from the logical AND gate 24 rises to a logical high voltage level, the recorded message is retrieved from the message memory 20 and played for the caller. Otherwise, if the message answer mode switch 22 is in the non-message mode, no message is played for the caller after the connection is opened. When the user is then ready to join the call, the user speaks into the microphone 16 and joins the call. The user then terminates the call by pressing the end call button.

The automatic answering and message system of the present invention enables a user to configure a telephone to automatically answer an incoming call and play a recorded message for the caller, allowing the user to get to a more opportune place to take the call.

Preferably, the automatic answering and message circuit of the present invention is implemented within a cellular telephone. Alternatively, as should be apparent to those skilled in the art, the automatic answering and message circuit of the present invention can be implemented on any telephone.

The present invention has been described in terms of specific embodiments incorporating details to facilitate the understanding of the principles of construction and operation of the invention. Such reference herein to specific embodiments and details thereof is not intended to limit the scope of the claims appended hereto. It will be apparent to those skilled in the art that modifications may be made in the embodiment chosen for illustration without departing from the spirit and scope of the invention.

I claim:

1. A method of automatically answering an incoming call on a telephone comprising the steps of:
a. detecting an incoming call;
b. automatically answering the incoming call thereby forming a connection;
c. playing a message over the connection; and
d. holding the connection open until joined by a user.

2. The method as claimed in claim 1 wherein the step of automatically answering is completed after allowing the incoming call to ring once.

3. The method as claimed in claim 1 further comprising the step of recording the message.

4. The method as claimed in claim 1 wherein the telephone is a cellular telephone.

5. The method as claimed in claim 1 wherein the call is joined by the user by pressing an answer key on the telephone.

6. The method as claimed in claim 1 further comprising the step of determining if the telephone is in an automatic mode.

7. The method as claimed in claim 6 further comprising the step of disabling the step of automatically answering the incoming call if it is determined that the telephone is not in the automatic mode.

8. The method as claimed in claim 1 further comprising the step of determining if the telephone is in a message mode.

9. The method as claimed in claim 8 further comprising the step of disabling the step of playing a message if it is determined that the telephone is not in the message mode.

10. The method as claimed in claim 1 further comprising the step of flashing a light on the telephone after the incoming call is automatically answered and until the connection is joined by the user.

11. An automatic answering and message apparatus comprising:
a. a detecting circuit for detecting an incoming telephone call on a telephone;
b. an answering circuit coupled to the detecting circuit for automatically answering the incoming telephone call thereby forming a connection; and
c. a memory and playback circuit coupled to the answering circuit for storing a message and playing the message over the connection;
wherein after the message is played, the connection is held open until joined by a user.

12. The automatic answering and message apparatus as claimed in claim 11 wherein the answering circuit allows the incoming call to ring once before automatically answering the incoming call.

13. The automatic answering and message apparatus as claimed in claim 11 wherein the user records the message within the memory.

14. The automatic answering and message apparatus as claimed in claim 11 wherein the telephone is a cellular telephone.

15. The automatic answering and message apparatus as claimed in claim 11 further comprising an automatic mode switch for switching between an automatic mode and a manual mode, wherein the answering circuit is only enabled when the automatic mode switch is in the automatic mode.

16. The automatic answering and message apparatus as claimed in claim 11 further comprising a message mode switch for switching between a message mode and a non-message mode, wherein the memory and playback circuit is only enabled when the message mode switch is in the message mode.

17. The automatic answering and message apparatus as claimed in claim 11 further comprising a notifying circuit for notifying the user that the connection is being held, wherein the notifying circuit is enabled after the answering circuit automatically answers the incoming telephone call and until the connection is joined by the user.

18. The automatic answering and message apparatus as claimed in claim 17 wherein the notifying circuit includes a flashing light.

19. A telephone comprising:
a. a detecting circuit for detecting an incoming call;
b. an automatic mode switch for switching between an automatic mode and a manual mode;
c. an answering circuit coupled to the detecting circuit and to the automatic mode switch for automatically answering the incoming telephone call if the automatic mode switch is in the automatic mode thereby forming a connection;
d. a message mode switch for switching between a message mode and a non-message mode; and
e. a memory and playback circuit coupled to the answering circuit and to the message mode switch for storing a message and playing the message over the connection if the message mode switch is in the message mode.

20. The telephone as claimed in claim 19 wherein the answering circuit allows the incoming call to ring once before automatically answering the incoming call.

21. The telephone as claimed in claim 19 wherein the user records the message within the memory and playback circuit.

22. The telephone as claimed in claim 19 wherein the telephone is a cellular telephone.

23. The telephone as claimed in claim 19 further comprising a notifying circuit for notifying the user that the connection is being held, wherein the notifying circuit is enabled after the answering circuit automatically answers the incoming telephone call until the connection is joined by the user.

24. The telephone as claimed in claim 23 wherein the notifying circuit is a light which flashes when enabled.

25. The telephone as claimed in claim 19 wherein the automatic mode switch is an external switch.

26. The telephone as claimed in claim 19 wherein the automatic mode switch is an internal switch which is programmed by the user.

27. The telephone as claimed in claim 19 wherein the message mode switch is an external switch.

28. The telephone as claimed in claim 19 wherein the message mode switch is an internal switch which is programmed by the user.
